(19) United States
(12) Patent Application Publication
(10) Pub. No.: US 2025/0291739 A1
(43) Pub. Date: Sep. 18, 2025

(54) CRYPTO-AGILE FIRMWARE UPDATE

(71) Applicant: Intel Corporation, Santa Clara, CA (US)

(72) Inventors: Nikola RADOVANOVIC, Los Altos, CA (US); Christine E. SEVERNS-WILLIAMS, Deephaven, MN (US); Yarden HAREVEN, Jerusalem (IL); Stanley Sundar PAUL, Chennai (IN); Marek ZMUDA, Rumia (PL); John BARRY, Co. Galway (IE)

(21) Appl. No.: 19/225,610

(22) Filed: Jun. 2, 2025

(51) Int. Cl. G06F 12/14; G06F 12/02

(52) U.S. Cl. CPC G06F 12/1408; G06F 12/0238; G06F 2212/1052

(57) ABSTRACT

Examples described herein relate to updating a cryptographic process. In some examples, circuitry is to update a cryptographic process by a write of a firmware image to a non-volatile memory; authenticate the firmware image based on a hash value stored in One Time Programmable Memory (OTPM); and permit execution of the authenticated firmware image to perform the cryptographic process.

Cryptography is utilized to encrypt and secure data and executable code to prevent unauthorized access or modification. The European Telecommunications Standards Institute (ETSI) and other standards bodies have recognized that a cryptographically relevant quantum computer (CRQC) can break and/or weaken existing cryptographic systems using Shor's or Grover's Algorithms or other possible future methods. In particular, Shor's algorithm directly breaks RSA encryption, whose security depends on the difficulty of factoring large prime numbers. Similarly, Shor's algorithm solves the discrete logarithm problem in finite fields and elliptic curves, which means it can break Diffie-Hellman key exchange, DSA/ECDSA digital signatures, and elliptic-curve cryptography as well. The impact of a CRQC is catastrophic as RSA, Diffie-Hellman, and ECC, which are widely used in security protocols and systems today would no longer be secure once a CRQC is available for relevant key sizes. The United States National Institute of Science and Technology (NIST) initiated a process to solicit, evaluate, and standardize quantum-resistant public-key cryptosystems. NIST develops and publishes Federal Information Processing Standards (FIPS) and also develops and publishes other non-FIPS standards and recommendations, such as NIST Special Publications (SPs).

### BRIEF DESCRIPTION OF THE DRAWINGS

FIG. 1 depicts an example system.

FIG. 2 depicts an example operation to add a firmware image.

FIG. 3 depicts an example operation to add a second firmware image and revoke use of a previously added firmware image.

FIG. 4 depicts an example process.

FIG. 5 depicts an example process to update an immutable and non-malleable hardware root of trust (ROT) firmware.

FIG. 6 depicts an example computing system.

### DETAILED DESCRIPTION

A computing platform can include processors and devices that access, decrypt, and execute encrypted and authenticated firmware and access, decrypt, and process encrypted data. A computer platform's lifetime can span years and regulatory institutions may change recommendations regarding cryptosystems during the lifetime of the platform. Capability to patch or update cryptosystems (e.g., cryptographic algorithms or implementations of cryptographic algorithms) in the platform can allow for the platform to conform to applicable cryptosystem regulations or customer specified requirements. Accordingly, crypto-agility is critical to improving the lifespan of a platform.

To meet new standards or resolve weaknesses and vulnerabilities in cryptographic algorithms and their implementations, various systems can add firmware that can patch, update, or add the quantum-resistant cryptosystem and store a hash value of the added firmware into One-Time Programmable (OTP) memory (OTPM) (e.g., fuses, array of fuses, etc.). An OTPM-stored hash value can be utilized to authenticate the added firmware allowing the update to become part of an immutable and non-malleable hardware Root of Trust (RoT) of the system. The added or additional firmware (e.g., crypto-agile firmware or cryptosystem) can perform quantum-resistant cryptographic operations to authenticate signatures of software or firmware or perform other functions requiring quantum resistant cryptographic operations including but not limited to attestation protocols, where the added cryptosystem become part of the hardware ROT. The platform can, at run-time, authenticate added firmware by calculating a hash value over the added firmware and comparing the calculated hash value with the hash value previously stored in the OTPM. The added firmware can add a cryptographic process that is considered or currently believed to be quantum-resistant. Based on a match of the calculated hash value with the hash value stored in the OTPM, the added firmware can be permitted to execute. Based on a mismatch of the calculated hash value with the hash value stored in the OTPM, the added firmware can be denied to execute and an error can be indicated by a boot processor to a data center administrator via a variety of technologies. Various examples are described herein with respect to addition of additional firmware to provide quantum resistance, however, examples need not apply to addition of quantum resistant firmware and can apply to non-quantum resistant firmware.

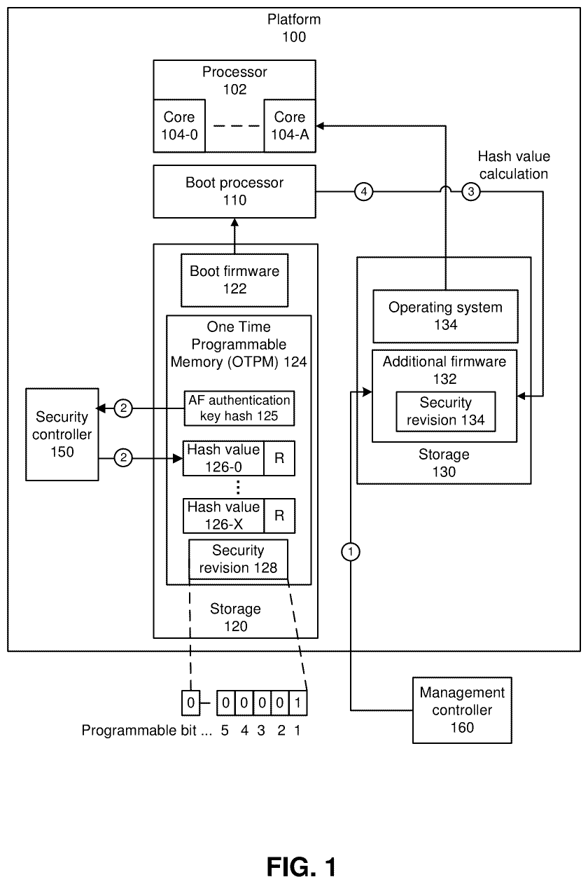

FIG. 1 depicts an embodiment. Processor 102 can include zero or more cores 104-0 to 104-A, where A is an integer. If processor 102 is present, zero or more of cores 104-0 to 104-A can include an execution core or computational engine that is capable of executing instructions. If processor 102 is present, zero or more cores 104-0 to 104-A can access its own cache(s) and read only memory (ROM), or multiple cores can share cache(s) or ROM or may not include any ROM or cache. If processor 102 is present, zero or more of cores 104-0 to 104-A can be homogeneous (e.g., same processing capabilities) and/or heterogeneous devices (e.g., different processing capabilities). If present, processor 102 may contain zero or more of cores 104-0 to 104-A which can be sold or designed by Intel®, Advanced RISC Machines (ARM)®, Advanced Micro Devices, Inc. (AMD)®, Qualcomm®, IBM®, Nvidia®, Broadcom®, Texas Instruments®, or any core compatible with reduced instruction set computer (RISC) instruction set architecture (ISA) (e.g., RISC-V), among others.

If processor 102 is present, zero or more of cores 104-0 to 104-A can utilize a system agent or uncore circuitry (not shown) that can include zero or more of a memory controller, a cache coherency manager, arithmetic logic units, floating point units, core or processor interconnects, Caching/Home Agent (CHA), interface circuitry (e.g., fabric, memory, device), bus or link controllers (e.g., Advanced Microcontroller Bus Architecture (AMBA) capabilities), direct memory access (DMA) engine, or others.

During reset or boot of platform 100, boot processor 110 can access boot firmware code 122 from storage 120. Storage 120 can be any type of non-volatile memory or immutable storage. Immutable storage (e.g., boot ROM) can store boot firmware code 122 but not permit alteration of boot firmware code 122 (e.g., read, modify, and write of boot firmware code 122 or writing over boot firmware code 122). Boot processor 110 can be any type of processor, accelerator, or controller (e.g., microcontroller). Boot processor 110 may be a separate entity or may be combined with security controller 150. Boot firmware code 122 can have a header file that identifies a map of what boot code is to be copied by boot processor 110. For example, a .h file for a boot firmware code can have a flash image layout map of which segments of boot firmware code 122 are to be copied. When executed by boot processor 110, boot firmware code 122 can be executed to perform hardware initialization during a booting process (e.g., power-on startup).

In some embodiments, boot firmware code 122 can be the lowest level firmware which will perform basis configuration and security functions (e.g. secure boot) prior to loading one or more of: Basic Input/Output System (BIOS), Universal Extensible Firmware Interface (UEFI), or a boot loader.

After manufacture of platform 100 and during utilization by a customer of platform 100, cryptographic subsystems or functions can be added as a part of runtime mutable firmware (FW) 132 in addition to the boot firmware 122. Firmware 132 can address issues with cryptographic algorithms, such as implementation or with non-algorithmic elements of a boot flow. Additional firmware 132 can perform quantum resistant cryptography and provide a crypto agile firmware update. Additional firmware 132 can be stored in storage 130 (e.g., non-volatile memory (NVM)). In some examples, firmware 132 can implement stateless Post-Quantum Cryptography (PQC) algorithms defined by NIST in the platform's lifetime and provide ability for the PQC algorithms to be included as part of the hardware Root of Trust (RoT) of platform 100 and to be used for secure boot and other boot time functions. Hash value 126 can be used to authenticate firmware 132 and can be stored in any type of OTPM 124 (e.g., a fuse, fuse array, or others).

As described herein, OTP memory 124 can store a minimum security revision 128 identifier to implement anti-rollback to prevent execution of a prior version of additional firmware 132. For example, minimum security revision 128 can be implemented as a string of multiple one time programmable bits (e.g., monotonic counter). Initially, all of the multiple one time programmable bits can be unprogrammed (shown as 0 values) to indicate that no additional firmware 132 is present to be checked for possible execution, e.g., for inclusion into the hardware RoT. Security version number (SVN) 128 of 0 indicates no additional firmware is present. When first additional firmware 132 is uploaded to platform 100, the first one time programmable bit of SVN 128 (programmable bit 1) changes to a value of 1 to indicate that additional firmware 132 exists and is at version 1. If a security revision 134 indicates a version that is less than a minimum acceptable version of additional firmware 132, boot firmware 122 does not permit execution of the additional firmware 132. Depending on policy selection, the boot loader and remaining firmware may not be loaded and executed.

Boot processor 110, can execute boot firmware 122 and as part of that execution can authenticate firmware 132 by calculating a hash value on all or less than an entirety of a file of firmware 132 and comparing the calculated hash value with hash 126 value stored in OTP 124. In order for the hash comparison to occur, the provided hash value 126 must not be revoked (e.g., R=0). In some examples, a cryptographic hash value may be calculated by use of Federal Information Processing Standard (FIPS) PUB 180-4 Secure Hash Standard (SHS) (March 2012), FIPS 202 or other hash standards.

An example of operations to utilize firmware 132 can be as follows. At (1), management controller 160 can provide additional firmware 132 for storage in storage 130. Management controller 160 can be positioned outside or inside of chassis of platform 100 and connected to storage 120 and storage 130 via a bus, cables and/or connectors. Additional firmware 132 could include implementations of new or evolving post-quantum cryptographic algorithms. Additional firmware 132 could remove compromised implementations of post-quantum cryptographic algorithms. Examples of post quantum cryptography can include at least: FIPS 203, FIPS 204, FIPS 205, or others future algorithms.

At (2), management controller 160 can provide signed additional firmware 132 with hash value 126 and, if the signature is approved by security controller 150 (which may be a separate entity or part of the boot processor 110), security controller 150 can store authenticated hash value 126 in OTP memory 124 directly without any ability for other entities to modify hash value 126 to guarantee security of the hash value. For example, multiple hash value slots (e.g., 126-0 through 126-X, where X is an integer) can be available to store hash values for additional firmware. An approved signing service may be used to provide signed additional firmware 132 to security controller 150 for authenticating firmware 132 based on a key using a stateful hash-based signature algorithm such as those defined by NIST SP800-108. The signed additional firmware 132 provided by the management controller can be signed with the Leighton-Micali Signature (LMS) or eXtended Merkle Signature Scheme (XMSS) algorithm. In some examples, security controller 150 can verify a public key used in the LMS or XMSS algorithm by comparing a hash of the public key received with additional firmware 132 and comparing such hash with a hash of the public key (e.g., additional firmware (AF) key hash 125), which is part of hardware RoT, from OTPM 124 (or boot ROM). In some examples, a revocation flag (R), also stored in OTPM, can indicate if hash value 126 or subsequent hash value is revoked or not.

A signing service, such as those operated by processor manufacturers, can create a public-private key pair. The key pair can be non-revocable. A key pair can be created using a stateful hash-based signature algorithm, such as XMSS: extended Merkle Signature Scheme (XMSS) (e.g., Internet Research Task Force (IRTF) Request for Comments (RFC) 8391 (2018)), Leighton-Micali Signatures (LMS) (e.g., IRTF RFC 8554 (2019)), or NIST SP800-208 in order to be resistant to quantum computing. A private LMS or XMSS key can sign image 132 directly without any child keys. Security controller 150 can use the corresponding public LMS or XMSS key to authenticate a signature of image 132 and can calculate hash value 126-0. Hash value 126-0 can be sent via a private bus from security controller 150 to OTP memory 124, that has one sender and one receiver and no intermediaries (e.g., point to point), to prevent altering of the hash value. In some examples, security controller 150 can perform read validation and programming of hash value 126-0 into OTPM 124. Anti-rollback can be implemented by checking a minimum security revision number in OTPM 124 prior to programming hash value 126-0.

At (3), boot processor 110 executing boot firmware 122 can compute a hash value over a whole or less than whole of a file of firmware 132 by a SHA2-512 calculation, or other cryptographic hash calculation of sufficient strength to be quantum resistant. Boot firmware 122 can verify firmware 132 by comparing a hash value computed over firmware 132 with a non-revoked hash value 126-0 programmed in OTP memory 124. For example, hash value 126-0 can be identified as non-revoked based on a value of revocation flag (R) stored in OTP memory 124.

At (4), based on authentication of firmware 132 by matching of a hash calculated on firmware 132 with non-revoked hash value 126-0, boot firmware 122 can load firmware 132 from storage 130. Firmware 132 can provide post-quantum cryptographic processes or algorithms that are defined or refined after manufacture of platform 100.

While examples are described with respect to firmware utilized by a processor, examples can be utilized to update or modify firmware utilized by a network interface device, an accelerator, or other circuitry.

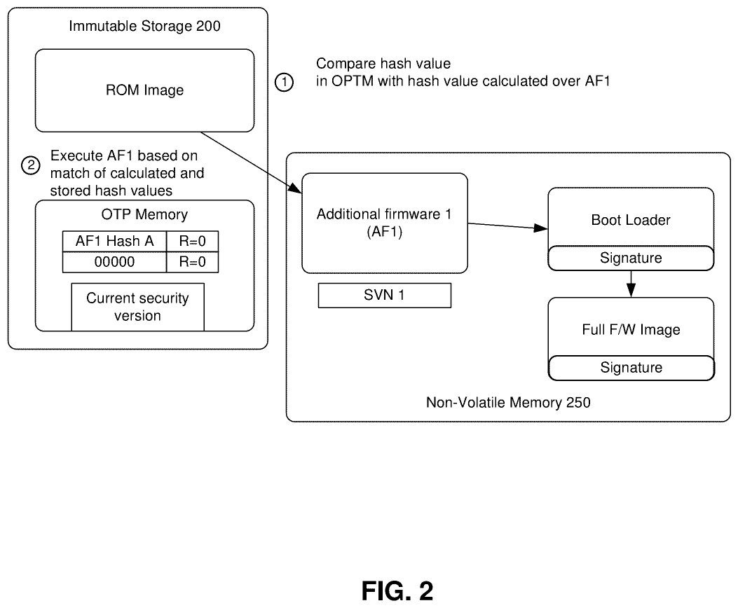

FIG. 2 depicts an example operation to add a firmware image to a platform (e.g., platform 100). At (1), during boot or after reset of platform, boot ROM image stored in immutable storage 200 can discover additional firmware 1 (AF1) stored in NVM 250, calculate a hash value over a file of the AF1, and compare the calculated hash value to a non-revoked (e.g., R=0) hash stored in OTP memory as AF1 Hash A. As shown, OTP memory can store a valid hash as AF1 Hash A, which is not revoked (e.g., an AF1 hash) and an associated revocation bit (R) set to not revoked.

In addition, at (1), a security version (SVN 1) of the additional firmware 1 (AF1) can be compared against a security version number of zeros stored in OTPM. If the security version stored in the OTPM is non-zero, additional firmware 1 may be permitted to be loaded by boot ROM image.

At (2), if the hash value in the OTP memory matches the hash value, calculated over AF1 which is stored in non-volatile memory 250, the code in AF1 can be executed by a microcontroller (e.g., boot processor 110 or other circuitry). AF1 code can perform post quantum cryptographic asymmetric algorithms to authenticate digital signatures of a boot loader or firmware (FW) image or other operations which rely on cryptographic operations within a hardware Root of Trust. A signing service which generates the signatures for boot loader and firmware image in NVM 250 may be managed by a silicon manufacturer, original equipment manufacturer (OEM), or service provider. The boot loader and FW image can be updated after manufacture of a platform (e.g., platform 100). A bootloader can run at a beginning of a system's boot process and load an operating system (OS). Based on a boot loader signature matching a signature calculated by AF1, boot loader can load the OS for execution by a processor. Execution of AF1 code can provide cryptographic services within a Root of Trust, including encryption, decryption, authentication, attestation, access control, or other operations.

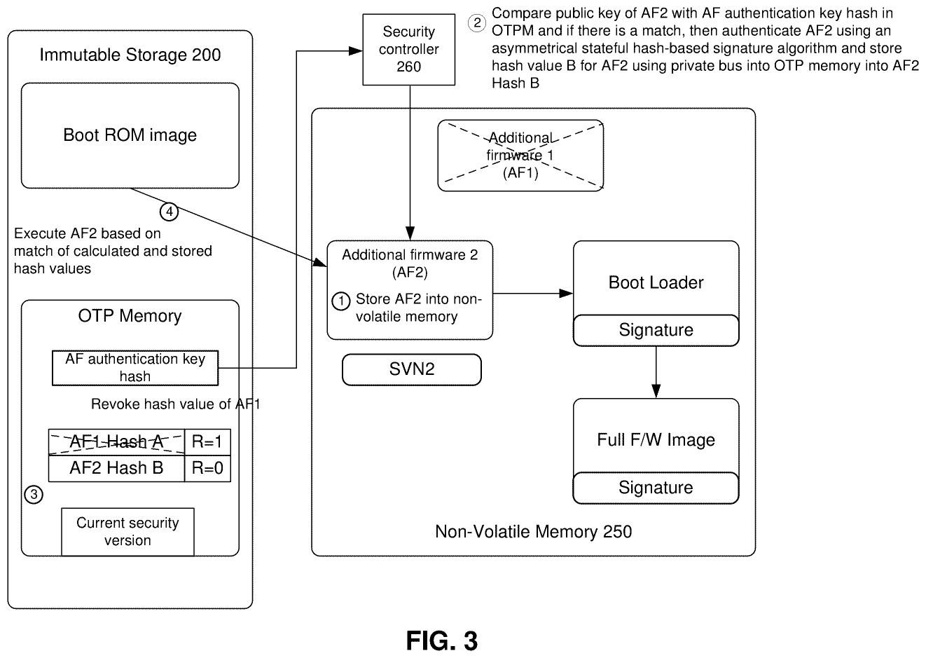

FIG. 3 depicts an example operation to add a second additional firmware (that becomes part of the immutable hardware root of trust if authenticated) and revoke use of a previously added AF1 image. Adding second additional firmware can enable a new cryptographic algorithm or patch an existing algorithm (e.g., AF1 or ROM image), either due to issues in implementation or issues with the algorithms themselves. In this example, at (1), a second additional firmware (e.g., AF2) can be stored in NVM 250 and a hash value for AF2 can be stored in an OTPM as AF2 Hash B. For example, at (2) security controller 260 can compare public key received with AF2 with AF authentication key hash in OTPM. If there is a match, then security controller 260 can use an asymmetrical hash-based stateful signature algorithm (e.g., NIST SP800-208 LMS or XMSS, or others) to authenticate AF2 and if authenticated, security controller 260 can send AF2 hash B to non-volatile memory 250 on a private bus. As shown, OTP memory can store a valid hash as AF2 Hash B, which is not revoked and an associated revocation bit (R) set to not revoked (e.g., R=0).

In addition, at (1), a security version (SVN 2) of the AF2 can be compared against minimum security version number and if the security version is less than the minimum security version number, AF2 may not be permitted to be stored in NVM 250 or loaded by boot ROM image.

At (3), a security controller can revoke AF1 Hash A stored in OTP memory by setting R=1 to disable use of AF1 by boot ROM image. For example, multiple one time programmable bits can be allocated per hash value. One of the multiple one time programmable bits can be allocated to indicate a hash value is valid or not revoked. In some examples, non-revoked additional firmware (AF1) is not revoked until second additional firmware (AF2) is validated and successfully boots the system.

At (4), when a platform is reset, boot ROM image can authenticate the image of additional firmware 2 (AF2) by calculating a hash value over a file of the AF2 and comparing the calculated hash value to a non-revoked hash stored in OTP memory as AF2 Hash B. At (3), if the hash value AF2 Hash B in the OTPM matches the hash value calculated over AF2, the code in AF2 can be executed by a microcontroller (e.g., boot processor 110 or other circuitry). Authenticated AF2 can authenticate digital signatures of a boot loader and full firmware (FW) image or other operations.

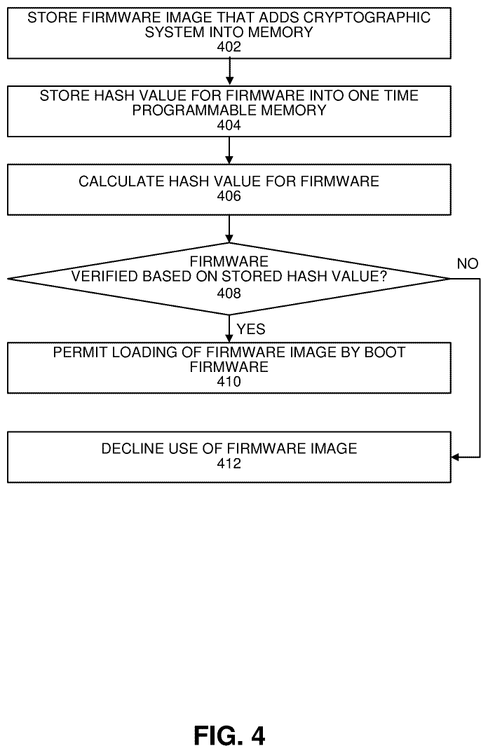

FIG. 4 depicts an example process. The process can be performed by a computing platform to update a firmware image that can add or update one or more cryptographic processes to a platform. At 402, a firmware image that can add a cryptographic process for use by a platform can be stored to non-volatile memory. The cryptographic process can be resistant to breaking by a quantum computer. At 404, an authenticated hash value for the firmware image can be stored into one time programmable memory. A flag can be stored that indicates that the firmware image is not revoked or valid. At 406, the platform can calculate a hash value on a whole or less than a whole of the firmware image. At 408, a determination can be made as to whether there is a match between the stored hash value and calculated hash value. Based on a match, the process can proceed to 410 and permit a boot firmware to execute the added authenticated firmware. Based on non-matching of the stored hash value and calculated hash value, the process can proceed to 412 and not permit boot firmware to execute the added firmware. In addition, a system administrator or orchestrator can be notified of access to unauthenticated firmware.

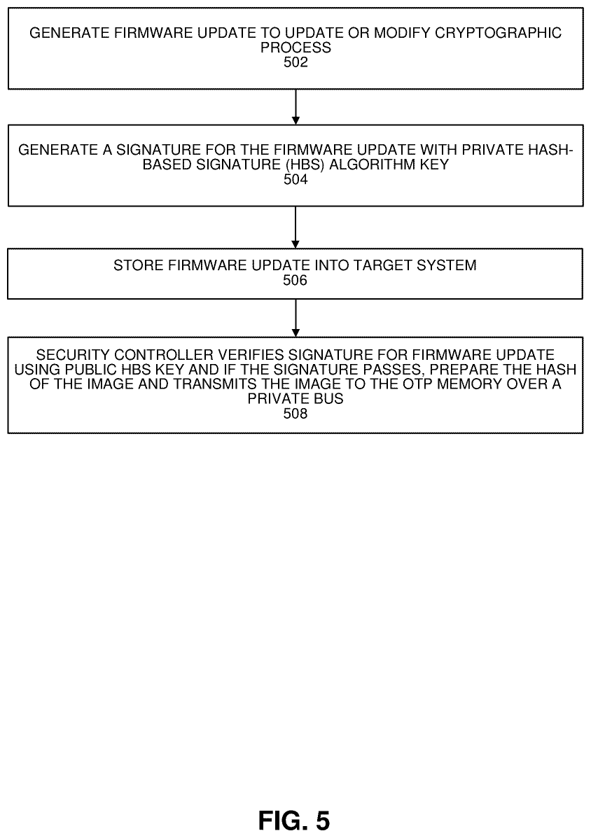

FIG. 5 depicts an example process to make a firmware update that adds or modifies a cryptographic subsystem or process. At 502, a manufacturer of a processor or platform that utilizes firmware can generate firmware that adds or modifies cryptographic subsystems. At 504, a signature can be generated over a firmware image update. A private hash-based signature algorithm can be used to generate the signature for the firmware image update. The process of generating a signature over a firmware image involves first creating a hash of that image which is then signed. At 506, the firmware image update can be stored on a memory of a platform or device. At 508, a security controller can verify the signature that is provided with the firmware update. If the hash-based signature is authenticated, the hash value can be sent to the OTP memory over a private bus and stored into OTP memory. The hash value can be utilized to verify the firmware image update. If the hash-based signature is not authenticated, the hash value is not stored to the OTP memory and a data center administrator can be alerted of an error.

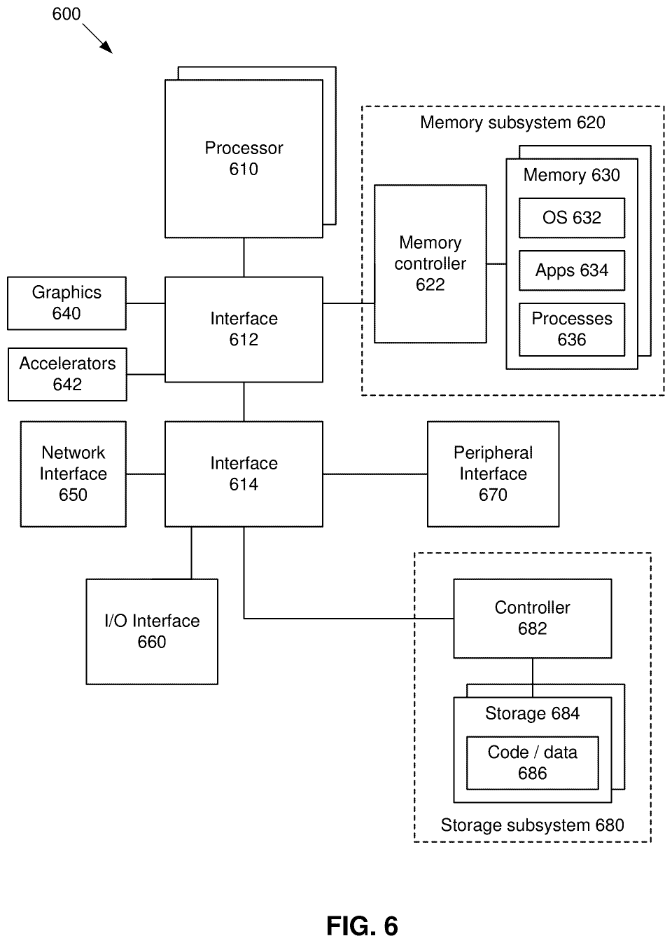

FIG. 6 depicts a system. In some examples, a processor (e.g., processor 610, graphics 640, or network interface 650) can access a firmware update that adds or modifies cryptographic processes, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. For example, accelerators 642 can include a load balancer accelerator or circuitry. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”'

Illustrative examples of the devices, systems, and methods disclosed herein are provided below. An embodiment of the devices, systems, and methods may include any one or more, and any combination of, the examples described below.

Example 1 includes an apparatus that includes: an interface to a One Time Programmable Memory (OTPM) and circuitry, coupled to the interface, the circuitry to: update a cryptographic process by a write of a firmware image to a non-volatile memory; authenticate the firmware image based on a hash value stored in the OTPM; and permit execution of the authenticated firmware image to perform the cryptographic process.

Example 2 includes one or more examples, wherein the cryptographic process comprises a quantum-resistant cryptographic process.

Example 3 includes one or more examples, wherein: the circuitry is to perform anti-rollback of the firmware image by checking a security revision in the OTPM prior to storing the hash value in the OTPM.

Example 4 includes one or more examples, wherein the circuitry is to: store the hash value in the OTPM is based on verification of a hash of a public key associated with the firmware image against a hash value stored in the OTPM and the firmware image being signed and authenticated one time using a stateful hash-based signing algorithm.

Example 5 includes one or more examples, wherein the circuitry is to revoke usage of a first firmware image by revocation of a first hash value associated with the first firmware image after a second hash value associated with a second firmware image is stored in the OTPM.

Example 6 includes one or more examples, wherein the execution of the authenticated firmware image is to provide cryptographic services within an immutable Root of Trust.

Example 7 includes one or more examples, and includes a method that includes updating a cryptographic process in a platform by storing a firmware image to the platform and storing a hash value of the firmware image in the OTPM; authenticating the firmware image based on the hash value; and permitting execution of the authenticated firmware.

Example 8 includes one or more examples, wherein the firmware image comprises a second firmware image and comprising: revoking a first firmware image by revoking a first hash value associated with the first firmware image.

Example 9 includes one or more examples, and includes storing the hash value in the OTPM based on successful authentication of the firmware image using a stateful hash-based signature algorithm which produces a resultant hash value of the firmware.

Example 10 includes one or more examples, and includes performing anti-rollback of the firmware image by checking a security revision in the OTPM prior to storing the hash value in the OTPM.

Example 11 includes one or more examples, and includes the executed authenticated firmware providing cryptographic services within an immutable Root of Trust.

Example 12 includes one or more examples, and includes a security engine generating the hash value by performing an asymmetrical signature verification using a post quantum hash-based stateful signature algorithm and storing the hash value in the OTPM by communication over a private point-to-point bus to prevent modification of the hash value prior to storing the hash value to the OTPM.

Example 13 includes one or more examples, and includes performing anti-rollback of the firmware image by checking a security revision in the OTPM prior to storing the hash value in the OTPM.

Example 14 includes one or more examples, and includes at least one non-transitory computer-readable medium comprising instructions stored thereon, that when executed by one or more processors, cause: execution of a firmware that is to: based on detection of an additional firmware: calculate a hash value on the additional firmware; access a hash value, associated with the additional firmware, stored in one time programmable memory; and permit execution of the additional firmware based on matching of the calculated hash value and the stored hash value, wherein the additional firmware performs a cryptographic process.

Example 15 includes one or more examples, and instructions stored thereon, that when executed by one or more processors, cause: storing the hash value in a One Time Programmable Memory (OTPM) based on the successful authentication of the additional firmware using a stateful hash-based signature algorithm.

Example 16 includes one or more examples, wherein the cryptographic process comprises a quantum-resistant cryptographic process.

Example 17 includes one or more examples, wherein the hash value length is consistent with quantum-resistant cryptography.

Example 18 includes one or more examples, and includes instructions stored thereon, that when executed by one or more processors, cause: the firmware to revoke usage of the additional firmware by revocation of a first hash value associated with the additional firmware, wherein a second hash value is stored in a One Time Programmable Memory (OTPM) prior to revocation of the first hash and wherein the second hash value is associated with a second additional firmware.

Example 19 includes one or more examples, wherein the execution of the additional firmware is to authenticate a signature of a boot loader and wherein the boot loader is to load an operating system.

Example 20 includes one or more examples, wherein the executed authenticated firmware providing cryptographic services within an immutable Root of Trust.

1. An apparatus comprising:
an interface to a One Time Programmable Memory (OTPM) and
circuitry, coupled to the interface, the circuitry to:
update a cryptographic process by a write of a firmware image to a non-volatile memory;
authenticate the firmware image based on a hash value stored in the OTPM; and
permit execution of the authenticated firmware image to perform the cryptographic process.

2. The apparatus of claim 1, wherein the cryptographic process comprises a quantum-resistant cryptographic process.

3. The apparatus of claim 1, wherein:
the circuitry is to perform anti-rollback of the firmware image by checking a security revision in the OTPM prior to storing the hash value in the OTPM.

4. The apparatus of claim 1, wherein the circuitry is to:
store the hash value in the OTPM is based on verification of a hash of a public key associated with the firmware image against a hash value stored in the OTPM and the firmware image being signed and authenticated one time using a stateful hash-based signing algorithm.

5. The apparatus of claim 1, wherein the circuitry is to revoke usage of a first firmware image by revocation of a first hash value associated with the first firmware image after a second hash value associated with a second firmware image is stored in the OTPM.

6. The apparatus of claim 1, wherein the execution of the authenticated firmware image is to provide cryptographic services within an immutable Root of Trust.

7. A method comprising:
updating a cryptographic process in a platform by storing a firmware image to the platform and storing a hash value of the firmware image in a One Time Programmable Memory (OTPM);
authenticating the firmware image based on the hash value; and
permitting execution of the authenticated firmware.

8. The method of claim 7, wherein the firmware image comprises a second firmware image and comprising:
revoking a first firmware image by revoking a first hash value associated with the first firmware image.

9. The method of claim 7, comprising:
storing the hash value in the OTPM based on successful authentication of the firmware image using a stateful hash-based signature algorithm which produces a resultant hash value of the firmware.

10. The method of claim 7, comprising:
performing anti-rollback of the firmware image by checking a security revision in the OTPM prior to storing the hash value in the OTPM.

11. The method of claim 7, comprising:
the executed authenticated firmware providing cryptographic services within an immutable Root of Trust.

12. The method of claim 7, comprising:
a security engine generating the hash value by performing an asymmetrical signature verification using a post quantum hash-based stateful signature algorithm and storing the hash value in the OTPM by communication over a private point-to-point bus to prevent modification of the hash value prior to storing the hash value to the OTPM.

13. The method of claim 12, comprising:
performing anti-rollback of the firmware image by checking a security revision in the OTPM prior to storing the hash value in the OTPM.

14. At least one non-transitory computer-readable medium comprising instructions stored thereon, that when executed by one or more processors, cause:
execution of a firmware that is to:
based on detection of an additional firmware:
calculate a hash value on the additional firmware;
access a hash value, associated with the additional firmware, stored in one time programmable memory; and
permit execution of the additional firmware based on matching of the calculated hash value and the stored hash value, wherein the additional firmware performs a cryptographic process.

15. The non-transitory computer-readable medium of claim 14, comprising instructions stored thereon, that when executed by one or more processors, cause:
storing the hash value in a One Time Programmable Memory (OTPM) based on successful authentication of the additional firmware using a stateful hash-based signature algorithm.

16. The non-transitory computer-readable medium of claim 14, wherein the cryptographic process comprises a quantum-resistant cryptographic process.

17. The non-transitory computer-readable medium of claim 14, wherein a length of the hash value is consistent with quantum-resistant cryptography.

18. The non-transitory computer-readable medium of claim 14, comprising instructions stored thereon, that when executed by one or more processors, cause:
the firmware to revoke usage of the additional firmware by revocation of a first hash value associated with the additional firmware, wherein a second hash value is stored in a One Time Programmable Memory (OTPM) prior to revocation of the first hash and wherein the second hash value is associated with a second additional firmware.

19. The non-transitory computer-readable medium of claim 14, wherein the execution of the additional firmware is to authenticate a signature of a boot loader and wherein the boot loader is to load an operating system.

20. The non-transitory computer-readable medium of claim 14, wherein the executed additional firmware provides cryptographic services within an immutable Root of Trust.
